(19) United States
(12) Patent Application Publication
(10) Pub. No.: US 2001/0039547 A1
(43) Pub. Date: Nov. 8, 2001

(54) Internet web-based technology for storing, archiving, and updating key personal identity items

(76) Inventors: Jonathan K. Black, Alphartta, GA (US); Todd M. Powell, Alpharetta, GA (US)

Correspondence Address: TECHNOPROP COLTON, L.L.C., P O BOX 567685, ATLANTA, GA, 311567685

(21) Appl. No.: 09/849,695

(22) Filed: May 4, 2001

Related U.S. Application Data
(60) Provisional application No. 60/202,678, filed on May 8, 2000.

(51) Int. Cl. G06F 17/30; G06F 17/60

(52) U.S. Cl. 707/102; 707/10; 707/200; 705/52; 707/104.1; 705/7

(57) ABSTRACT

A method of creating a relational database with personal and professional information about individuals by obtaining information from at least one information source, wherein the information is obtained and updated automatically on a predetermined periodic basis from the at least one information source; inputting the information into a relational database within a predetermined time from when the information is obtained from the at least one information source, wherein old information contained in the database is constantly replaced by new information; sorting the information into at least one searchable unit within the database; and allowing at least one entity access to the information contained in the database for the purpose of determining whether the entity desires to enter into, maintain or terminate a relationship with an individual.

### CROSS-REFERENCE TO RELATED APPLICATIONS

This application claims priority on U.S. Provisional Patent Application No. 60/202678 filed on May 8, 2000.

### BACKGROUND OF THE INVENTION

1. Technical Field

The invention is in the general technical field of Internet web-based technologies for storing, archiving, and updating information, and is in the more specific technical field of Internet web-based technologies for storing, archiving, and updating key personal data, identity, credential, and professional items for and by digital partners.

2. Prior Art

Various entities constantly need updated and verified information on particular individuals. For example, hospitals constantly need information regarding doctors having or applying for privileges at the hospitals, state bars constantly need information regarding lawyers licensed or applying for a license to practice in that state, and the Federal Aviation Administration constantly needs information regarding flight controllers or people applying to be flight controllers. The list of entities is endless, and the number of potential individuals needing to be verified or credentialed is growing. Although this process has several different names, credentialing is one of the most common.

Currently, every time an entity needs to verify the qualifications or history of an individual, the entity either has to conduct its own investigation or hire a third party to conduct an investigation into the individual. For example, seven different interested entities, such as hospitals and medical insurance companies may have to obtain the credentials of the same seven different consenting individuals, such as doctors. This is done all of the time, and there are many companies that specialize in so-called credentialing of individuals. Currently, each interested entity has to conduct its own credentialing of each consenting individual.

Three main problems associated with the current methods of credentialing individuals are the cost, the time necessary to conduct an acceptable investigation of an individual, and the need to conduct separate investigations of a single individual by several different entities at the same time or by one entity at different times. For example, a doctor may have privileges at several different hospitals. Each hospital must conduct a separate investigation into the doctors' history and credentials. Further, hospitals may be required to conduct such investigations periodically. Similarly, state bars must conduct background investigations into the history of each potential lawyer applying for a license to practice in a certain state. Also, other entities, such as the Federal Aviation Administration or professional membership organizations, must investigate the backgrounds of flight controllers or members, respectively, to determine whether the individuals are acceptable for certain jobs or certifications. As can be seen, the list of entities is endless.

Thus, it can be seen that the current methods of credentialing individuals is expensive, time-consuming, and unnecessarily redundant, and there is a need for a less-costly, fast, and overreaching method. The present invention is directed to this need.

### BRIEF SUMMARY OF THE INVENTION

A method and business process for selectively storing, archiving, and updating key personal identity items related to documentation of an individual's professional credentials and/or documents using a secure Internet platform with a web-enabled software package that interfaces with a relational database to update, edit, and/or delete key profile attributes on selected owner-providers. This invention allows users from global locations to store personal identity information, which is accessible via the Internet, and enables users to have a central secure, safe location to disseminate information that they wish to share, document, and/or replicate for transmission to interested parties whishing to verify critical elements of the information that have been stored, authenticated, and converted for on-line viewing.

Various individuals and organizations must provide access to or obtain access of personal information. For example, many professionals, such as doctors, lawyers, accountants, and pilots, to name a few, must provide certain personal information to government, organizational, sanctioning, professional, and other bodies to satisfy certain requirements. Likewise, many organizations, such as hospitals, bar associations, state governments, and airlines, to name a few, must obtain certain personal information about its employees or members to satisfy their due diligence in associating with such members. The present invention provides for a central, continuously updated, real-time database of such information, which can be accessed by the appropriate individuals in providing personal information to such organizations and by such organizations in credentialing such individuals.

The method of the invention generally comprises generating on-line realtime profiles of individuals using the latest personal information updates from information sources that have access to update the central repository of information, automating the process of sending and receiving personal information updates, importing personal information from information sources, documenting and validating the personal information, legitimizing and authenticating the personal information and the sources from which the personal information is provided, allowing queries regarding particular persons and their personal information, manipulating key data elements to provide appropriate reports, documenting the place of origin of the personal information, storing digital representations of the personal information, and providing the personal information to users in an appropriate form.

A representative sampling of the personal profile attributes that can be stored, archived, and/or updated by the invention includes but is not limited to papers, e-mails, photos, voice prints, DNA samples, fingerprints, DMV reports, credit reports, personal journals, information submissions from government regulatory agencies, video transmissions, financial disclosures, authenticated legal documents and agreements, diplomas and certificates, professional certifications from accredited training sources, professional affiliations, professional licenses, professional board affiliations, professional organization memberships, teaching positions, professional positions, resumes, and other professional and personal information.

An object of this invention is to provide a method for creating an on-line, real-time, updateable database containing pertinent information regarding consenting individuals that can be accessed by the appropriate entity for ascertaining the history and credentials of the consenting individuals.

Another object of the present invention is to provide a method allowing individuals to store and update on-line and in real-time their professional and personal backgrounds for use and review by interested entities.

Another object of the present invention is to provide a method allowing entities to investigate on-line and in real-time the professional and personal backgrounds of consenting individuals.

Another object of the present invention is to provide a method allowing the continuous and real-time credentialing of consenting individuals.

Another object of the present invention is to provide a method for collecting and maintaining a database of personal information of consenting individuals for use by or resale to others.

Another object of the present invention is to provide a method for consenting individuals, interested entities and information providers to interact in real-time and to share information regarding the consenting individuals in particular to help the interested entities determine whether the consenting individuals want to establish, continue or terminate a relationship with the consenting individuals.

These objects, and other objects, features and advantages of the invention, will become more apparent to those of ordinary skill in the art when the following detailed description of the preferred embodiments is read in conjunction with the appended figures.

### BRIEF DESCRIPTION OF THE DRAWINGS

FIG. 1 is a prior art credentialing process wherein individual interested entities contact individual information providers to obtain information about consenting individuals.

FIG. 2 is a prior art credentialing process wherein individual interested entities contact a credentialing party who then contacts individual information providers to obtain information about consenting individuals.

FIG. 3 is a flow chart schematically illustrating the present method.

FIG. 4 is a flow chart schematically illustrating the verification model used to maintain the relational database of the present invention.

FIG. 5 is a flow chart schematically illustrating an alternate embodiment of the present method.

### DETAILED DESCRIPTION OF THE INVENTION

The present invention is a method and business process for selectively storing, archiving and updating key personal identity items related to documentation of a consenting individual's professional credentials and/or documents that may include any or all of those disclosed herein using a secure Internet platform with a web-enabled software package that interfaces with a relational database to update, edit, and/or delete key profile attributes on selected owner-providers.

As discussed above, various interested entities constantly need updated and verified information on particular consenting individuals. For example, hospitals constantly need information regarding doctors having or applying for privileges at the hospitals, state bars constantly need information regarding lawyers licensed or applying for a license to practice in that state, and the Federal Aviation Administration constantly needs information regarding flight controllers or people applying to be flight controllers. The list of interested entities is endless, and the number of potential consenting individuals needing to be verified or credentialed is growing.

The present invention is a method to create and maintain a database of personal information that can be accessed on an as needed basis to verify information regarding certain consenting individuals. Such a method potentially can reduce the costs associated with the credentialing and investigative process by reducing the time needed to conduct such investigations, eliminating the need to hire multiple investigative entities, and reducing the amount of data entry and the redundancy of data entry by multiple entities. Further, the interested entities may be able to reduce their liability to others based on the actions of members and associates by allowing the interested entities to obtain up-to-date information about members and associates and to cease relationships more quickly with undesirable consenting individuals.

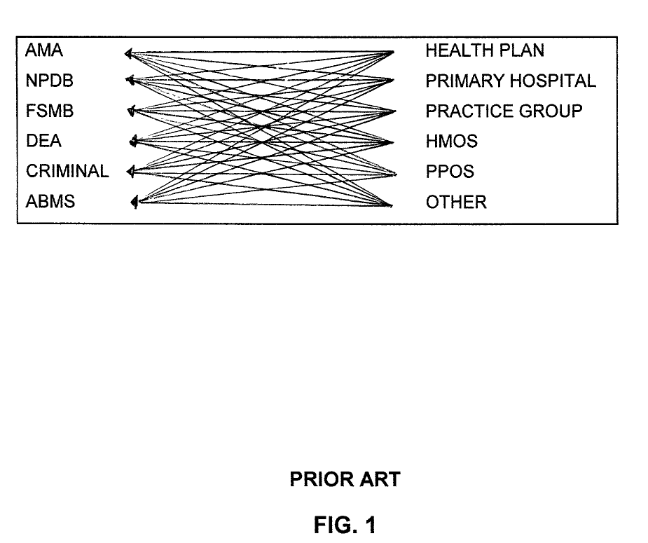

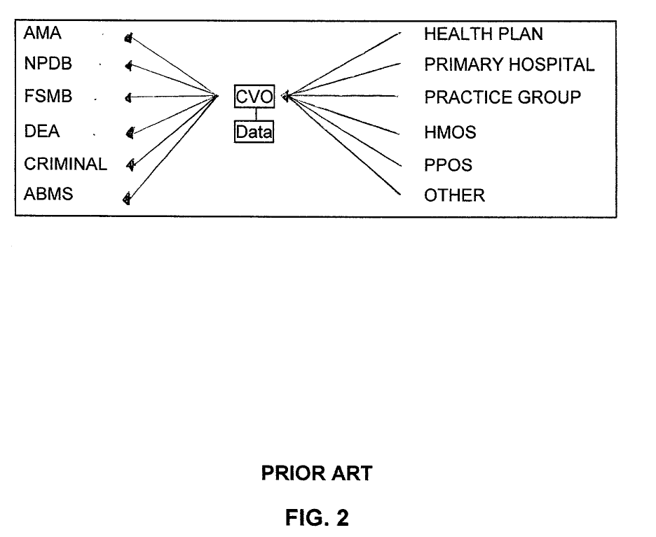

FIGS. 1 and 2 show prior art credentialing processes. In the example shown in FIG. 1, the interested entities are health plans primary hospitals, medical practice groups, health maintenance organizations (HMOs), preferred provider organizations (PPOs) and other entities. The information providers are the AMA, the NPDB, the FSMB, the DEA, criminal record databases, and ABMs. The consenting individuals are doctors. However, the credentialing processes are equally applicable to other professionals and non-professionals alike. For example, in the legal and accounting professions, interested entities such as bas associations and accounting associations want background information on lawyers and accountants.

Referring now to FIG. 1, a first prior art process for credentialing consenting individuals is shown. This basically is an every man for himself process. Each interested entity must contact each information provider to request information about each consenting individual, The process is redundant, as each interested entity must contact each information provider for the same information about the same consenting individuals.

Referring now to FIG. 2, a second prior art process for credentialing consenting individuals is shown. This process is somewhat more efficient than the process shown in FIG. 1, but still is inefficient. This basically is a middleman process. A middleman entity, or CVO, is hired by an interested entity to credential a consenting individual. Other interested parties also may hire the same CVO and request information about the same consenting individual. The CVO contacts the information providers and obtains the information about the consenting individual. If the requests by the interested parties are made at about the same time, the CVO can provide each interested party with the same information about the consenting individual without having to do another credentialing process. However, this contemporaneous request almost never happens, and the CVO must conduct another credentialing process on the same consenting individual.

As can be seen in FIGS. 1 and 2, the request for information flows in only one direction. Interested entities are constantly actively querying information providers, who react. Information providers do not act proactively in the current market.

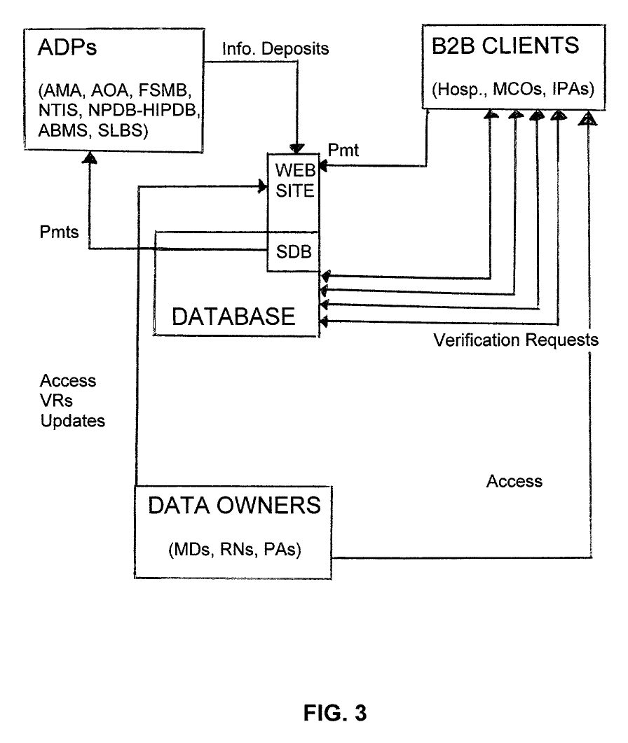

Referring now to FIG. 3, the present method is shown schematically. Authorized digital relationships (ADRs) are established with information providers, also referred to as authorized digital partners (ADPs). For example, the ADRs may, and preferably does, provide that the ADPs provide information about all of the members and associates of the ADPs. These members make up the bulk of the consenting individuals.

A database is created with original information about the consenting individuals. The ADPs contribute information about consenting individuals to the database through a secure Internet web site. The ADPs can update the information in the database periodically or continuously. For example, some ADPs can update information about their consenting individuals yearly, monthly, weekly or on any desired periodic basis. Other ADPs can update information about their consenting individuals as soon as new information becomes available. ADPs preferably have the opportunity and ability to have an always-on connection to the database, and constantly and consistently update information about their consenting individuals, thus allowing the database to be always up to date.

This relationship between the database, which is maintained at a separate site, is a paradigm shift from the current methods of credentialing. As mentioned above, in the current credentialing processes, the interested parties or CVOs, which stand in the shoes of the database, constantly must query the information providers. In the present method, the information providers constantly update the database. So instead of the interested parties or CVOs acting and the information providers reacting, the information providers are acting and the database is reacting.

The interested parties, also referred to as business-to-business clients or B2B Clients, now query the database for information about consenting individuals. Typically, the query is in the form of a search of the database for the digital file on the consenting individual. The digital of information about the consenting individual is readily available, and is as accurate and up-to-date as the most recent information supplied by the ADPs. Thus, rather than having to react to a query to credential a consenting individual, such as the CVOs or interested entities currently do, the database provides the requested information in real time. In effect, credentialing is eliminated in favor of an up-to-date, constantly updated database of information about consenting individuals.

This also is a paradigm shift from the current methods of credentialing. Individual interested entities no longer have to contact individual information providers or CVOs and have new credentialing reports produced on consenting individuals. The information on consenting individuals is already on the database, and is up-to-date.

Consenting individuals, also known as Data Owners, must give their consent to the interested entities to request the information and give their consent to the ADPs to provide the information. Consenting individuals also can have access to the database to inspect their own data (but not the data of other consenting individuals, unless otherwise authorized). If a discrepancy is found, the consenting individuals can request an update or correction, can post a note or explanation, or request an inquiry. In this way, there are several checks and balances on the information.

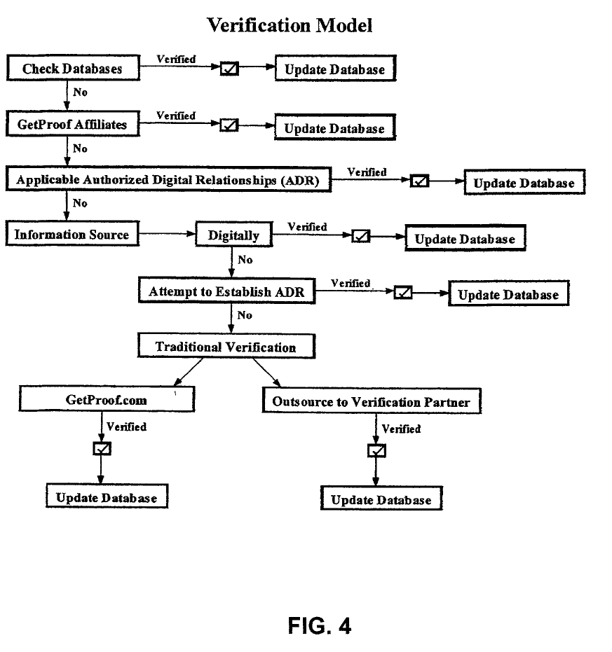

As the database is only as good as the information provided to it by the ADPs, it is preferable to have certain information verification procedures in place. Referring now to FIG. 4, a verification model is shown. The database can be checked for accuracy by the database maintainer by comparing the data in the database with the information resident at the information providers. Consenting individuals also can check the integrity of the database information and report to the database maintainer any inaccuracies or discrepancies. Inaccuracies or discrepancies can be corrected and the database updated. Similarly, affiliates of the database maintainers who are not necessarily ADPs, also referred to as GetProof Affiliates, who provide information to the databases can verify the information they provide to the database, and update the information provided as necessary. ADPs who have established ADRs with the database are constantly updating the database. In this process, the integrity of the information provided by through an ADR to the database constantly is being verified and updated.

At times, an interested entity will request information about a consenting individual who is not in the database, or will request information from an information source not providing information to the database. The database, or the database maintainer, can try to establish an ADR with the information source, or merely request a one-time download of data from the information source. If an ADR is established, the new information source provides information like any other ADP. If an ADR is not established, but the information source agrees to a one-time download of data, the information is provided digitally. The new information can be verified by comparing the information to the information source's database, or can be independently verified by the database maintainer, either internally, also referred to as GetProof.com, or externally through an affiliate, also referred to as outsource to Verification Partner.

As can be seen, the information provided to the database, whether by an ADP or by a non-ADP, is up-to-date and, if necessary, verified. This too is a paradigm shift from the current methods of credentialing in that the information is being provided digitally from the information sources'databases directly to the relational database, rather than through photocopies of documents provided by the information sources to the interested entities or CVOs.

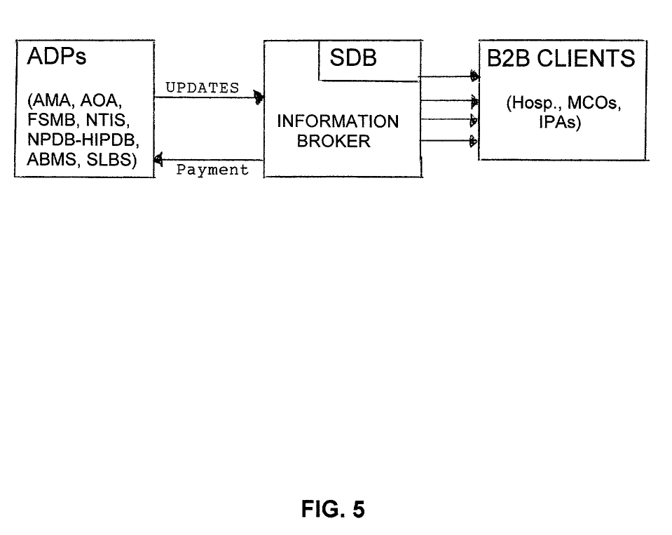

Referring now to FIG. 5, an alternate embodiment of the invention is shown. In this embodiment, the relational database acts as an information broker of information of consenting individuals. ADPs provide information to the database, and B2B Clients request and receive the information. The information can be gathered from consenting individuals, or can be gleaned from public records or purchased from commercial data providers. In this embodiment, the database can be considered a commercial database of information, and not necessarily a credentialing database.

As a business method, all parties involved in the method profit, either directly financially by the receipt of payments or indirectly by saving time and reducing redundancy. Referring to FIG. 3, ADPs can receive payments for providing information to the database. The database (the personification of the database owner or maintainer) can receive payments from the B2B Clients either as a subscription or on a per use basis, or in other manners. The B2B clients also save money due to the fewer number of redundant credentialing investigations they need to perform and the comparatively lower cost per credentialing event. The ADPs also save money due to the fewer redundant credentialing requests made of them, thus saving human time. The database preferably takes in more in payments than it pays out.

This is a further paradigm shift from the current methods of credentialing. ADPs actually can realize income by providing information to the database. Interested entities actually can reduce their credentialing costs by subscribing to the database, as each search for information about a consenting individual can be significantly less costly than the current credentialing investigations. While the database may realize less income per credentialing event, the sheer size of the database and/or the increased number of queries, or in other words an increase in volume, can make the database profitable.

The business method for the alternate embodiment of the invention shown in FIG. 5 assumes the database acts as an information broker. The database gathers information from ADPs and from any other information sources available. The data is collected, sorted, and made available on a payment basis to B2B Clients. ADPs can realize income by payments made by the database to the ADPs. The database can realize income from payments made by the B2B Clients to the database for information about consenting individuals (and publicly available information gleaned about non-consenting individuals).

The steps of the invention comprise:

Generating an on-line real-time profile (the database) with the latest updates from information partners (ADPs) who have access to update the central repository (the database) with pre-arranged security and access. Information partners (ADPs) include the various organizations that have pertinent personal information on the consenting individuals who are the subject of the inquiries by interested entities. Such organizations (ADPs) agree to provide and continuously update the personal information to the relational database used by the invention to store and archive the personal information. Information partners (ADPs) may include professional organizations such as the American Medical Association, the American Bar Association, the U.S. Drug Enforcement Agency, state agencies such as the state departments of motor vehicles and the state licensing departments, federal and state court systems and probation offices, schools and colleges, notary publics, and other federal and state agencies and department having pertinent personal information required or desired by the authorized digital partners.

Automating the process of sending and receiving updates of subsets of key data elements from web-agent messengers that assure a one-of-a-kind repository (the database) that can be accessed by subscription via the Internet or an intranet to verify, quantify, and validate information provided by ADPs. For example, information partners have the ability to update their particular portion of the relational database as often as they like, and preferably continuously as new information becomes available on individuals.

Importing critical information obtained from worldwide sources (public records or database) that can document, validate, and legitimize particular information elements, and distributing such critical information electronically via Internet enabled software that can be accessed using standard browser technology standards.

Completing a selection of key inquiries, which have been updated independently by authorized digital partners that enable the latest digital data available and authorized for view by the individual or entity storing elements in the repository.

Manipulating key data elements to allow unique comparison, data validation, and real-time reporting from, literally any combination of relationships, which is submitted from authorized digital partners.

Documenting the place of origin, storing the digital representation of the data, and validating the reception and time-line of particular digital archive elements, including but not limited to papers, e-mails, photos, voice prints, DNA samples, fingerprints, DMV reports, credit reports, personal journals, information submissions from government regulatory agencies, video transmissions, financial disclosures, authenticated legal documents and agreements, diplomas and certificate, professional certifications from accredited training sources, professional affiliations, professional licenses, professional board affiliations, professional organization memberships, teaching positions, professional positions, resumes, and other professional and personal information.

Preparing, receiving, storing, and responding to correspondence, which can be converted to digital format and stored with access by browser enabled software.

Allowing control of the digital information content by the owner (provider) of the content, and allowing the content owner to authorize access to and use of the content.

This unique and currently unavailable process enables individuals from global locations to store personal identity information, which is accessible via the Internet. These secure personal digital agents enable individuals to have a central secure, safe location to disseminate information to interested parties wishing to verify critical elements that have been stored, authenticated, and converted for on-line viewing by web-enabled software technology.

The above detailed description of the preferred embodiments and the appended figures are for illustrative purposes only and are not intended to limit the scope and spirit of the invention, and its equivalents, as defined by the appended claims. One skilled in the art will recognize that many variations can be made to the invention disclosed in this specification without departing from the scope and spirit of the invention.

What is claimed is:

1. A method of creating a relational database comprising the steps of:
a. obtaining information from at least one information source, wherein updated information is obtained automatically on a predetermined periodic basis from the at least one information source;
b. inputting the information into a relational database within a predetermined time from when the information is obtained from the at least one information source, wherein the information contained in the database is constantly replaced by the new information;
c. sorting the information into at least one searchable unit within the database; and
d. allowing at least one entity access to the information contained in the database.

2. The method as claimed in claim 1, wherein the information is personal information about at least one individual.

3. The method as claimed in claim 2, wherein the at least one information source is selected from the group consisting of government agencies, professional organizations, courts, educational institutions, licensing bodies, certification bodies, and legal business entities.

4. The method as claimed in claim 1, wherein the information is replaced by new information as soon as the new information becomes available.

5. The method as claimed in claim 2, further including the step of allowing at least one individual to access the database to review personal information about the at least one individual.

6. The method as claimed in claim 1, wherein the information is provided proactively from the at least one information source.

7. The method as claimed in claim 6, wherein the information is verified by the at least one information source.

8. The method as claimed in claim 6, wherein the information is verified by an independent party.

9. The method as claimed in claim 1, wherein the updated information is provided automatically to the at least one entity.

10. The method as claimed in claim 2, wherein the updated information is provided automatically to the at least one entity and the information is about the at least one individual.

11. A business method for providing information from a relational database comprising the steps of:
a. obtaining initial information from at least one information source;
b. inputting the information into a relational;
c. sorting the information into at least one searchable unit within the database;
d. obtaining updated information from the at least one information source;
e. replacing the initial information with the updated information within a predetermined time from when the updated information is obtained;
f. allowing at least one entity access to the information contained in the database;
g. repeating steps b through e as often as updated information is obtained; and
h. repeating step f as often as the at least one entity desires access to the information.

12. The business method as claimed in claim 11, wherein the database is owned by a database owner and wherein a payment is made by the database owner to the at least one information source for the provision of information.

13. The business method as claimed in claim 12, wherein the database is owned by a database owner and wherein a payment is made by the at least one entity to the database owner for access to the information.

14. The business method as claimed in claim 13, wherein the information is personal information about at least one individual.

15. The business method as claimed in claim 14, wherein the information is provided proactively from the at least one information source.

16. The business method as claimed in claim 15, wherein the information is provided automatically from the at least one information source.

17. The business method as claimed in claim 16, wherein the updated information is provided automatically to the at least one entity

18. The business method as claimed in claim 17, wherein the at least one entity automatically on a periodic basis receives information from the database regarding a number of discrete individuals identified by the at least one entity to the database.

19. The business method as claimed in claim 17, wherein the at least one entity receives upon request information from the database regarding a number of discrete individuals identified by the at least one entity to the database.

20. The business method as claimed in claim 19, wherein the at least one entity obtains the information about the at least one individual from the database for the purpose of determining whether the at least one entity desires to create, maintain or terminate a relationship with the at least one individual.

21. A method for collecting and providing information about individuals comprising the steps of:
a. obtaining information about individuals from at least one information provider;
b. entering the information about individuals into a relational database;
c. providing access to the relational database to at least one interested entity;
d. obtaining updated information about individuals from the at least one information provider;
e. comparing the updated information about individuals to the information entered into the relational database;
f. replacing the information entered into the relational database with the updated information about individuals if the updated information about individuals is more recent than the information entered into the relational database to create an updated relational database;
g. repeating steps d through f as additional updated information about individuals is obtained from the at least one information provider.

22. The method as claimed in claim 21, further comprising the step of:
h. transmitting the updated relational database to the at least one interested party.

23. The method as claimed in claim 21, wherein the information about individuals is obtained from the at least one information source on a constant periodic basis.

24. The method as claimed in claim 21, wherein the information about individuals is obtained from the at least one information provider on a continuous basis when updated information about individuals is available.

25. The method as claimed in claim 21, wherein the relational database is provided to the at least one interested entity on a constant periodic basis.

26. The method as claimed in claim 21, wherein the relational database is provided to the at least one interested entity on a continuous basis.

27. The method as claimed in claim 21, wherein the information about individuals is obtained from the at least one information provider on a continuous basis when updated information about individuals is available and the relational database is provided to the at least one interested entity on a continuous basis.

28. The method as claimed in claim 22, wherein the information about individuals is obtained from the at least one information provider on a continuous basis when updated information about individuals is available and the relational database is transmitted to the at least one interested entity on a continuous basis.

29. The method as claimed in claim 21, wherein the database is owned by a database owner and wherein a payment is made by the database owner to the at least one information source for the provision of information about individuals, and wherein a payment is made by the at least one interested entity to the database owner for being provided the information about individuals.

30. The method as claimed in claim 29, wherein the information is obtained automatically from the at least one information source and wherein the updated information is provided automatically to the at least one interested entity

31. The method as claimed in claim 30, wherein the at least one interested entity automatically on a periodic basis receives information from the database regarding a number of discrete individuals identified by the at least one interested entity to the database.

32. The method as claimed in claim 31, wherein the at least one interested entity obtains the information about the at least one individual from the database for the purpose of determining whether the at least one interested entity desires to create, maintain or terminate a relationship with the at least one individual.
